(19) United States
(12) Patent Application Publication
(10) Pub. No.: US 2023/0218993 A1
(43) Pub. Date: Jul. 13, 2023

(54) GOLF SIMULATOR WITH TOURNAMENT PLAY

(71) Applicant: Kevin Johnston, Brighton, MI (US)

(72) Inventor: Kevin Johnston, Brighton, MI (US)

(21) Appl. No.: 18/096,342

(22) Filed: Jan. 12, 2023

Related U.S. Application Data
(60) Provisional application No. 63/298,663, filed on Jan. 12, 2022.

(51) Int. Cl. A63F 13/48; A63F 13/73; A63F 13/79; A63F 13/812; G07F 17/32; A63F 13/533

(52) U.S. Cl. CPC A63F 13/48; A63F 13/73; A63F 13/79; A63F 13/812; G07F 17/3288; A63F 13/533; G07F 17/3244

(57) ABSTRACT

A system and method for creating an interactive remote golf game can comprise a processor configured to launch an application on a client computer, receive account login information, communicate with a web database to verify login information, display dashboard information, receive information regarding existing and possible golf rounds, output information regarding currently playable rounds and tournaments, receive information from a user regarding a new golf round with a set of defined rules and options for play by multiple remote users, send data to the web database regarding new round and defined rules and options for additional players to access with other instances of the application.

### CROSS REFERENCE

This application claims the benefit of U.S. provisional application No. 63/298,663, filed 12 Jan. 2022, which is hereby incorporated by reference in its entirety as though fully set forth herein.

### BACKGROUND OF THE DISCLOSURE

### a. Field

The present disclosure relates to systems and methods for simulating golf for individual and tournament play.

### b. Background Art

Playing golf is a sport loved by many with a variety of time consuming and inconvenient issues for many individuals. Time of year, location of the course, time of day, green fees, cost of travel to the course, and many other issues can cause even the most avid fans problems when trying to find time to play or challenge themselves with new courses and challenges. Additional issues can arise when an individual is attempting to play with business associates or friends or join a particular tournament or other type of game with a number of related or anonymous players. Popular courses additionally only have a certain number of players that are able to play on a particular day and timing of the players can be an issue when other conflicts or commitments arise.

Accordingly, there exists a need for a system and method for an individual or group to play specific courses and participate in certain group type play at a time and location more convenient, economical, and inclusive than that which currently exists.

### SUMMARY OF THE INVENTION

In various embodiments, a system for creating an interactive remote golf game can comprise a processor configured to launch an application on a client computer, receive account login information, communicate with a web database to verify login information, display dashboard information, receive information regarding existing and possible golf rounds, output information regarding currently playable rounds and tournaments, receive information from a user regarding a new golf round with a set of defined rules and options for play by multiple remote users, send data to the web database regarding new round and defined rules and options for additional players to access with other instances of the application.

In various embodiments, a method for creating an interactive remote golf game can comprise launching an application on a client computer, receiving account login information, communicating with a web database to verify login information, displaying dashboard information, receiving information regarding existing and possible golf rounds, outputting information regarding currently playable rounds and tournaments, receiving information from a user regarding a new golf round with a set of defined rules and options for play by multiple remote users, sending data to the web database regarding new round and defined rules and options for additional players to access with other instances of the application.

The foregoing and other aspects, features, details, utilities, and advantages of the present disclosure will be apparent from reading the following description and claims, and from reviewing the accompanying drawings.

### BRIEF DESCRIPTION OF THE DRAWINGS

FIG. 1 is a flowchart of the method of initial launch of an application of the software system on a computer.

FIG. 2 is flowchart of the method of navigating within the application after successful login.

FIG. 3 is a flowchart of the method of navigating within the tournaments section of the UI.

FIG. 4 is a flowchart of the method of navigating within the go golfing section of the UI.

FIG. 5 is a flowchart of the method of navigating within the store section of the UI.

### DETAILED DESCRIPTION OF EMBODIMENTS

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

The present disclosure is directed a system and method for playing golf and tournaments remotely as well as navigating a remote play system. In particular, the present disclosure enables a user to register, download, and play a variety of courses modeled after actual locations or existing only on the program. These courses can include varied weather while keeping the conditions the same for every competitor using the system in a specific or otherwise identified program or group. This can allow for specific challenges and

A user can enter the system described herein by downloading a computer program or visiting a website. In one embodiment, the downloaded computer program can comprise Orion Online provided by OptiShot Golf. In other embodiments, other software systems can be used. The software can be downloaded with a processor. The processor can further install and run the application on the client computer or stream information to a remote computer The processor can further run the features, UI, and methods and processes described herein within the application and external sites. The current disclosure includes an overall apparatus. The apparatus can include a computer system installed locally or remotely. The applications disclosed herein can further communication with a communications network through and over which one or more of the apparatuses may communicate or otherwise transmit/transfer data/information. It should be understood that the computer system running the software system has an electronic processor and associated memory configured to execute software code and that further each computer system also includes an electronic processor and associated memory configured to execute software code.

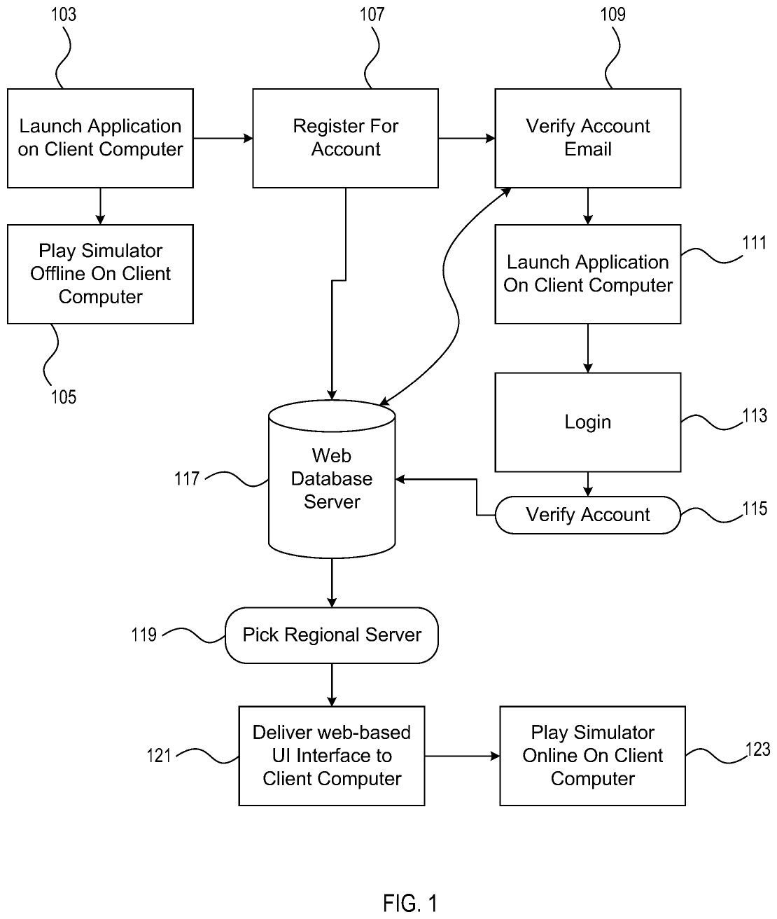

FIG. 1 is a flowchart of the method of initial launch of an application of the software system on a player or company computer as described herein. In step 103 a player can launch an application on a client computer. In other embodiments, the application can be opened by an owner of the system through which the player can purchase time to play. The player can choose to play the simulator in offline or online mode. In step 105 the player has chosen to play the simulator in offline mode. The application opens a local version of the application and no further registration or account login information can be required. In other embodiments, the application may request login information even when in offline mode. In step 107 the player has chosen to play in online mode. The player is taken to a screen within the UI of the application to Register and/or Login to the online mode. In one embodiment, the player is directed to step 109 where an email address entered by the player is verified. In one embodiment the email address is verified on a web database server controller as seen in step 117. Once the email address has been verified in step 109, the application can be launched on a client computer in step 111. In step 113, the application launches a page to allow the player to login to the service. In step 115 the account is verified. Step 117 comprises the application communicating with the Web Database Server Controller. The Web Database Server Controller communicates program information with the application. The player picks a regional server in step 119. In step 121 a web-based UI interface is delivered to the client computer. In step 123 the application communicates with the Web Database Server Controller to allow for the application to play the simulator online with the client computer. The processor described herein can continue to communicate with the Web Database Server Controller to communicate information to or from the application. In other embodiments, the processor can communicate with other web databases, processors, or systems to communicate information to the application of direct information from the application to a regional server or other remote server or processor.

In one embodiment the player can install an Orion Online software system. After a user installs the Orion Online software system, a player can be taken to the initial launch screen. From here, the user can register for a new account, log in to Orion Online if they already have credentials, or can play offline without needing any credentials. The Orion Online software system can further take inputs relating to shots taken by a player and use that information within the application to let the player remotely play golf within the Orion Online software system.

In one embodiment, if the user registers for an account, they fill out the registration form and verify that their email address is valid. If the user is in a jurisdiction where peer-to-peer wagering is legal, and they would like to participate in peer-to-peer wagering, they must also go through an identity verification process before they can purchase diamonds for wagering.

After logging into Orion Online, in one embodiment, at the first login, the user must choose a server to play on. In other embodiments, the user can change servers while in a session or after ending and starting a new session. Regional servers can provide the best play experience, but limits the user to playing against other players in the same region and/or on the same server. If the user joins the USA server, they will only be able to play against other players on the USA server and will not be able to play against someone on the European server. In yet other embodiments, cross server play is possible between identified players.

Once the user connected to the server, the latest version of the user interface (UI) will be downloaded into the local Orion Online software located on the client computer. This can allow for the dynamic updating of many game features without updating the client.

After the UI is delivered to the client, if the server detects that the client software executable is older than the latest version of the software on the server, the player will be prompted to download the latest version of the software and will not allow the player to use the Orion Online without updating.

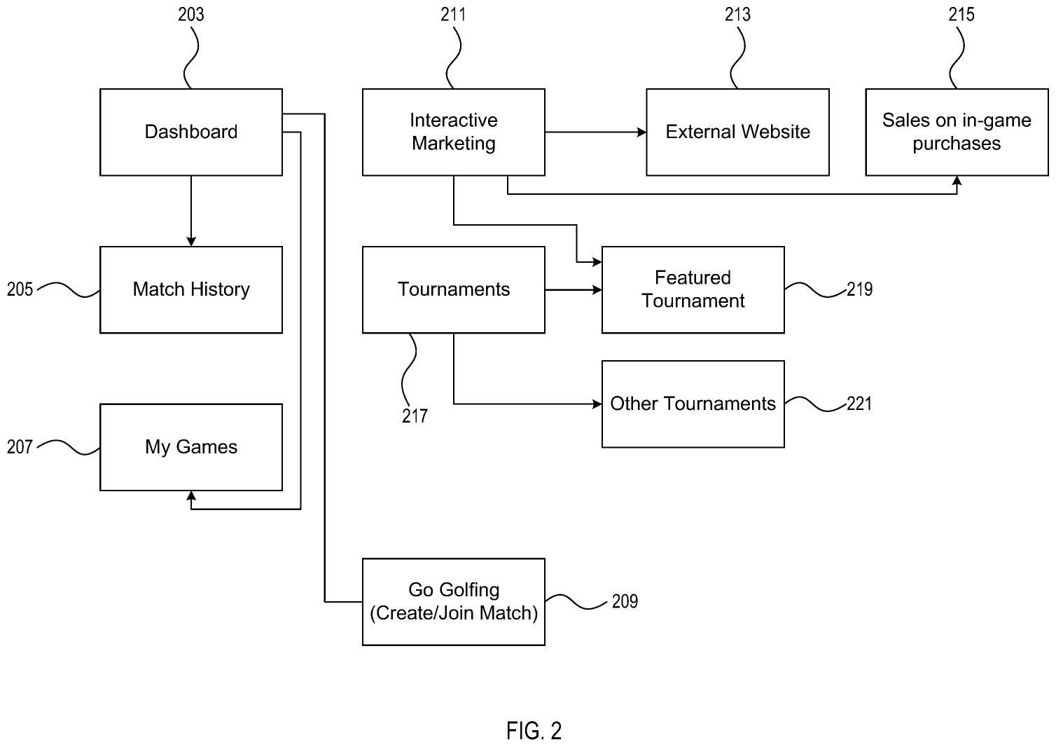

FIG. 2 is a flowchart of the method of navigating within the application after successful login as described herein. In step 203 the application displays the dashboard to the player. The dashboard can display a variety of options and/or graphics to the user. In one embodiment every option and/or graphic is clickable by the player. In another embodiment, some of the options and/or graphics are for informational or display purposes and are unable to be clicked by the player. The options and/or graphics can include a list of recently completed and in progress games. In some embodiments, the dashboard can further or alternatively include a list of favorite completed games. In another embodiment, the dashboard can include a clickable link for previously selected favorite games. In step 205, the player clicks on Match History of a specific recently completed game. When a player selects Match history, the application can display more information relating to that specific game. In step 207 the player can select My Games and be taken to a list and/or graphic of games the player is currently in progress playing, waiting for future rounds, or waiting for additional details. Additionally, in step 209 the player can select Go Golfing and the application can take the player to a new game creation process or list potential matches that the player can join. In one embodiment, step 209 can include a search function to allow the player to search for potential matches through name of the match, type of match, creator of match, course for the match, or additional information and categories.

Additionally, the dashboard can display interactive marketing and tournament information. In step 211 the player can select the interactive marketing materials. In step 213 the dashboard can send the player to an external website when the interactive marketing materials are selected. The external website can include additional information, registration forms, videos, and related materials. In step 215 the dashboard can send the player to information on in-game sales for courses, currency, collectibles, customizable materials or other for sale items. In step 219, the player can select featured tournaments that can be displayed by the application within the interactive marketing. This selection can take the player to showcased tournaments. In some embodiments the featured tournaments can include discounts, special prizes, unique features, or be similar to tournaments that the player has participated in the past. In step 217 the player can select tournament information. In step 219 the dashboard can send the player to the featured tournaments. In step 221 the dashboard can send the player to a listing of other tournaments available for the player to participate in.

In another embodiment, after successfully logging into the Orion Online software system and getting the latest version of the user interface (UI) the player will be taken to the Dashboard. In the dashboard the player will be presented with any interactive marketing graphics that may be available. The interactive marketing graphics can notify a player of a sale going on or other marketing that may be occurring relating to the program or related materials. In one embodiment, if a player clicks the advertisement, they will be taken out of the software program they are currently using, Orion Online in the instant embodiment, and the player's web browser will load and automatically take them to view the item featured in the advertisement. In other embodiments, the marketing graphics can take a user to a link or marketing material located within the software program. Some interactive marketing graphics will notify a player of a featured tournament, and if they click on those marketing graphics they will be taken directly to the featured tournament inside of the software program. In yet other embodiments, other marketing graphics may notify the player of in-game sales of playable courses or items or coins—and clicking on those marketing graphics will navigate directly to the item inside of the software program.

From the Dashboard, the player can also look at the text or image summary of the match history of completed or other matches. If a player clicks on a match history, they can be provided with more information on that particular match. The player can also look at current games in progress, and if the player clicks on those matches, they will be taken to the match in progress.

From the Dashboard, the player can also click on the Tournaments and Events button that will take them to the Tournaments and Events display. From the Tournaments and Events display the player can look at the information on any tournaments and events in progress or about to happen and join them if they choose.

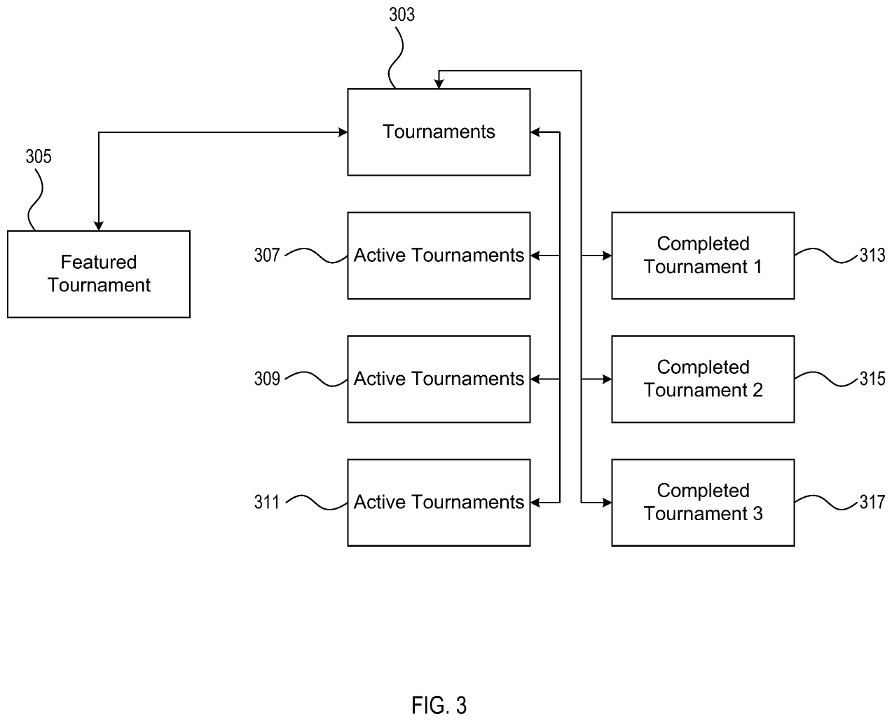

FIG. 3 is a flowchart of the method of navigating within the tournaments section of the UI of the instant application. In step 303, the player can select the tournament in the application UI which can bring the player to the tournament screen. In one embodiment, the tournament section of the application can list a number of featured tournaments, active tournaments, and completed tournaments. In step 305 the player selects featured tournaments and can be shown tournaments that can be of interest to the player. In steps 307, 309, and 311 the player can select various active tournaments that they can participate in. Additionally in steps 313, 315 and 317 the player can view tournaments that the player has recently finished. In another embodiment, the completed tournaments can further include favorited tournaments that the player would like to keep for ease of later review or for easy access of favorites shots or plays.

As seen in FIG. 3, in the illustrated embodiment, the Tournaments and Events area of the UI of the software program can show the featured tournament for the month or week (if any) as well as any tournaments that are currently in progress or will be coming up soon. Tournaments can have a specific start and end date, and can have multiple rounds. In one embodiment, any single-round tournament can be joined by players up until the tournament ends. In other embodiments, the creator or admin of a tournament can specify specific time limits for entering the tournament before the tournament ends. In another embodiment, a multi-round tournament is available for players to join round one up until the round ends, but subsequent rounds can only be played by participants from the first round according to the rules of the specific tournament. In other embodiments, the creator or admin of a tournament can create specific rules regarding that tournament and time limits for participants to join. Tournament prizes can be in-game currency or “just for fun” (no prize awarded). In-game prizes and awards can may be awarded as winner takes all, top 10 linear split, or top 50 linear split, among others as would be known to one or ordinary skill in the art. Additionally, the creator of a tournament can specify the type of award and process through which the in-game prizes and awards are determined. The application can communicate the information created and chosen by the player to the regional server or other remote system. This information can then be communicated to other version of the application and congregate data from those systems about results of players using and playing the tournament or round.

From the Tournaments and Events area, the player can also see the results of a certain number of the most recent tournaments that have been finished. In one embodiment, the player can see the most recent three tournaments that have finished.

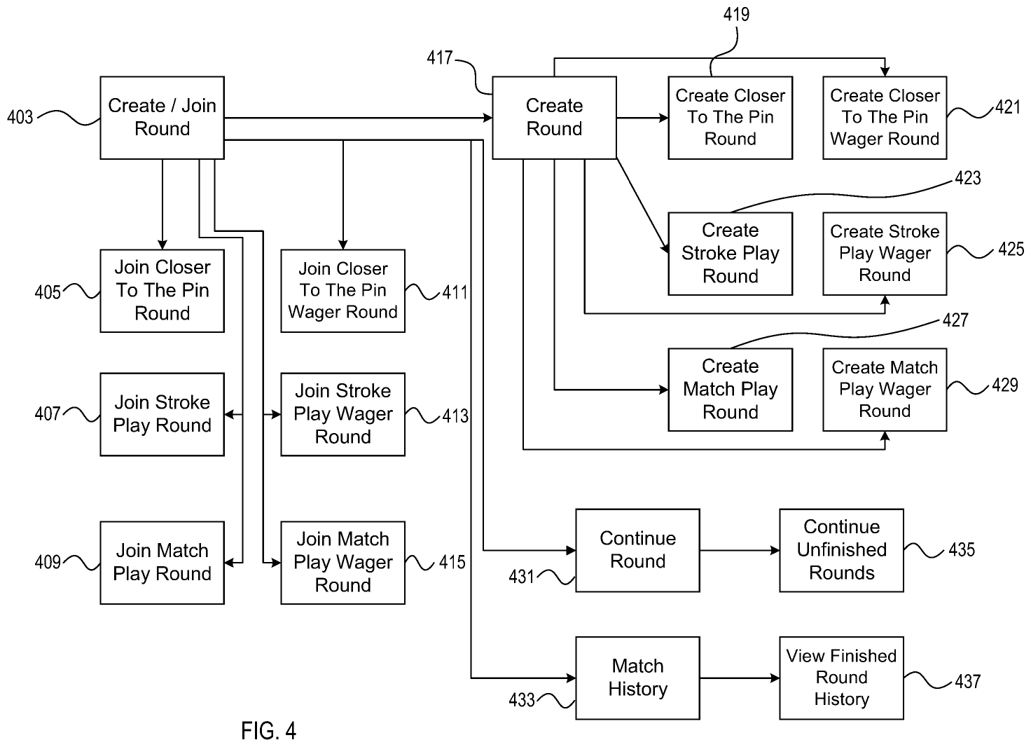

FIG. 4 is a flowchart of the method of navigating within the go golfing section of the UI of the instant application. In step 403 the player can select create and/or join round to be taken to the area of the application that the player can create a round or join a round created by another user. In this area of the application the player has the option of joining games that include wagering of in-game currency as well as games that do not include wagering. In step 405 the player can then select joining a closer to the pin round. In step 407 the player can then select joining a stroke play round. In step 409, the player can then select joining a match play round. In step 411 the player can then select joining a closer to the pin wager round. In step 413 the player can then select joining a stroke play wager round. In step 415 the player can then select joining a match play wager round. In step 431 the player can select continue round and go to a list of previously started but not yet finished rounds. In step 435 the player can then choose which of the previously started but unfinished rounds to play. In step 433 the player can select to view the match history of the account. In step 437 the player can then select a particular finished round history to review. Alternatively, if the player wants to create a round, they can perform that action from this portion of the application. In step 417 the player can select create round. In this area of the application the player has the option of creating games that include wagering of in-game currency as well as games that do not include wagering. In step 419 the player can then select creating a closest to the pin round. In one embodiment, the closest to the pin round can comprise th In step 423 the player can then select creating a stroke play round. In step 427 the player can then select creating a match play round. In step 421 the player can then select creating a closer to the pin wagering round. In step 425 the player can create a stroke play wagering round. In step 429 the player can create a match play wagering round. Each of the rounds can comprise their own rules and variable choices. As an example, for a closest to the pin round, either with or without wagering, the creator can set the number of participants that are allowed to play, whether the round is open to all players within the system or invited players only, the number shots that are allowed by the players, the club(s) that are able to be used by the players, the course(s) or hole(s) used during the round, a specific location of a hole, a green type, wind, precipitation, and other weather conditions, among other options. These variables can then be the same for each player as they play their round within the application. Additionally, the course conditions and layout can be changed for each shot as set-up by the creator of the round. In one embodiment, certain players can be handicapped by having specific conditions be different for different players. In one embodiment each of these variables are displayed to all players, including any handicapping information.

In the Orion Online software system after clicking into the Go Golfing area, the player can create a new round, join a round created by another player, or look at their match history.

All players will have the ability to join or create rounds that have no wagering. If a player is in a jurisdiction that allows social wagering, they will also be able to join or create rounds that have social wagers (coins). If they are in a jurisdiction that allows peer-to-peer wagers and have verified their identification, the player will also be able to join or create rounds that have money wagers. In one embodiment, the money wagers can comprise Diamond wagers. In this embodiment, Diamonds can be bought or sold for real-world money in the Diamond store. If the player has previously created or joined a round, and the round is not complete, from the Go Golfing area they can also choose to continue any rounds that have not been completed.

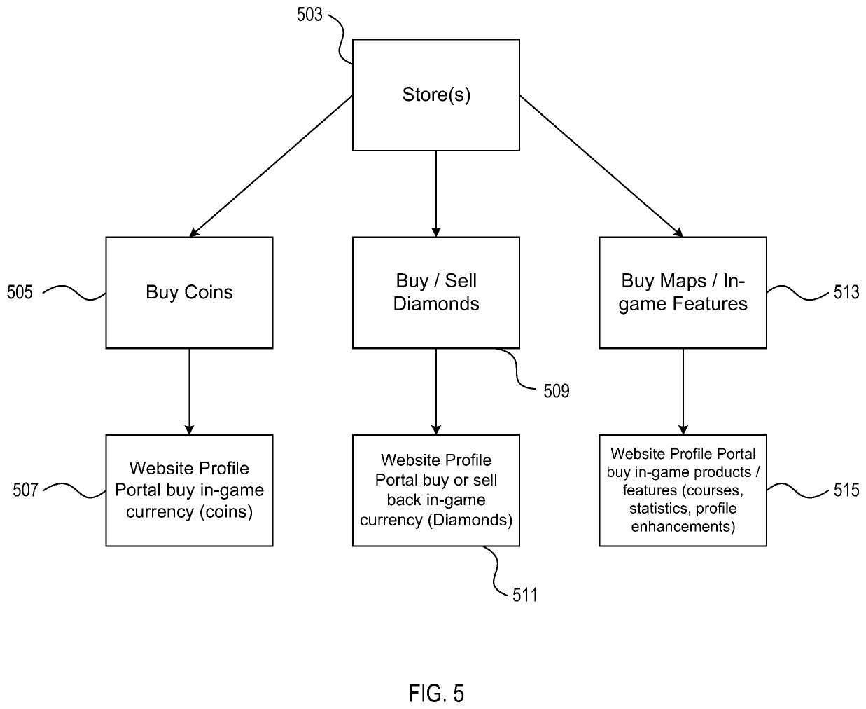

FIG. 5 is a flowchart of the method of navigating within the store section of the UI of the instant application. In step 503 the player can select the store and be taken to the area of the application that the player can buy and sell in-game currency, trade in-game currency for real-world currency, purchase in game maps and features. In step 505 the player can select to buy coins. In step 507 the player can be taken to a website profile portal to buy in-game currency. In step 509 the player can select to buy diamonds or premium tradeable currency. In step 511 the player can be taken to a website profile portal to buy or sell back in-game diamonds or premium tradeable currency. In step 513 the player can select to buy maps or in-game features. In step 515 the player can be taken to a website profile portal to buy in-game products or features. In the illustrated embodiment, the in-game products or features can include courses, statistics, profile enhancements, customizable loadouts, application enhancements, and other features.

In the illustrated embodiment shown in FIG. 5 there are three stores that can be available in the game, depending on what the player wants to purchase. In the illustrated embodiment, the store inside of Orion Online sells in-game features, and courses. The player can purchase these items using in-game currency (coins). When the player purchase these items, they are immediately available for download and use inside of Orion Online. The Buy Coins store can be launched when the player chooses to buy coins inside of Orion Online. This launches a web browser on their computer and prompts the player to log into their online account using the same username and password as their Orion Online account. From here, the player may securely purchase (using a 3rd party credit card vendor) additional coins for social wagering or for use to buy in-game features or courses. Coins are purchased only and have no cash value. In the illustrated embodiment, the Buy/Sell Diamonds store is only available to players in jurisdictions where peer-to-peer wagering is allowed, and if they have previously verified their identification. This store is launched when the player chooses to buy diamonds inside of Orion Online. This launches a web browser on the player's computer and prompts them to log into their online account using the same username and password as their Orion Online account. From here, the player may securely purchase (using a 3rd party credit card vendor) additional diamonds for peer-to-peer wagering. In one embodiment, Diamonds may be sold back using the same third-party vendor. In other embodiments, the player can use alternative vendors or methods to sell back Diamonds or other currency for cash value.

The software system, application, and method described herein can comprise additional features. In various embodiments the application can further comprise video content of live events, streaming media, photography, and fan action. Video content of live events can include clips, real world activities, video of shots and events happening within the app, and additional video. Streaming media can comprise live partner events, player streaming of play sessions, streaming of golfing events, etc. Photography within the application can comprise sharing features to share within the application, with Facebook, Instagram, Twitter, or other social media platforms. Fan action can comprise enabling audiences to bet on players, have a fantasy model for professional or application golfers, or other betting systems for games within the application as well as real-world events.

It should be understood that a processor as described herein may include conventional processing apparatus known in the art, capable of executing pre-programmed instructions stored in an associated memory, all performing in accordance with the functionality described herein. To the extent that the methods described herein are embodied in software, the resulting software can be stored in an associated memory and can also constitute the means for performing such methods. Implementation of certain embodiments, where done so in software, would require no more than routine application of programming skills by one of ordinary skill in the art, in view of the foregoing enabling description. Such a processor may further be of the type having both ROM, RAM, a combination of non-volatile and volatile (modifiable) memory so that any software may be stored and yet allow storage and processing of dynamically produced data and/or signals.

It should be further understood that an article of manufacture in accordance with this disclosure includes a computer-readable storage medium having a computer program encoded thereon for implementing the logic for determining the performance impact of changes in a computing system and other functionality described herein. The computer program includes code to perform one or more of the methods disclosed herein. Such embodiments may be configured to execute on one or more processors, multiple processors that are integrated into a single system or are distributed over and connected together through a communications network, and where the network may be wired or wireless.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially equal” is not otherwise clear to one of ordinary skill in the art in the context in which it is used and described in the present description, “substantially equal” will mean about equal where about is as described above. If the use of “substantially parallel” is not otherwise clear to one of ordinary skill in the art in the context in which it is used and described in the present description, “substantially parallel” will mean within 30 degrees of parallel. Directions or surfaces described as substantially parallel to one another may, in some embodiments, be within 20 degrees, or within 10 degrees of parallel, or may be parallel or nominally parallel. If the use of “substantially aligned” is not otherwise clear to one of ordinary skill in the art in the context in which it is used and described in the present description, “substantially aligned” will mean aligned to within 20% of a width of the objects being aligned. Objects described as substantially aligned may, in some embodiments, be aligned to within 10% or to within 5% of a width of the objects being aligned.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

Although several embodiments have been described above with a certain degree of particularity, those skilled in the art could make numerous alterations to the disclosed embodiments without departing from the present disclosure. It is intended that all matter contained in the above description or shown in the accompanying drawings shall be interpreted as illustrative only and not limiting. Changes in detail or structure may be made without departing from the present teachings. The foregoing description and following claims are intended to cover all such modifications and variations.

Various embodiments are described herein of various apparatuses, systems, and methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” “an embodiment,” or the like, means that a particular feature, structure, or characteristic described in connection with the embodiment is included in at least one embodiment. Thus, appearances of the phrases “in various embodiments,” “in some embodiments,” “in one embodiment,” “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation.

It will be appreciated that the terms “proximal” and “distal” may be used throughout the specification with reference to a clinician manipulating one end of an instrument used to treat a patient. The term “proximal” refers to the portion of the instrument closest to the clinician and the term “distal” refers to the portion located furthest from the clinician. It will be further appreciated that for conciseness and clarity, spatial terms such as “vertical,” “horizontal,” “up,” and “down” may be used herein with respect to the illustrated embodiments. However, surgical instruments may be used in many orientations and positions, and these terms are not intended to be limiting and absolute.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A system for creating an interactive remote golf game, comprising:
a processor, the processor configured to:
launch an application on a client computer;
receive account login information;
communicate with a web database to verify login information;
display dashboard information;
receive information regarding existing and possible golf rounds;
output information regarding currently playable rounds and tournaments;
receive information from a user regarding a new golf round with a set of defined rules and options for play by multiple remote users;
send data to the web database regarding new round and defined rules and options for additional players to access with other instances of the application.

2. The system of claim 1, wherein the new golf round can comprise one of a closest to the pin round, a stroke play round, and a match play round.

3. The system of claim 1, wherein the new golf round can a wagering round.

4. The system of claim 3, wherein the wagering comprises a premium currency.

5. The system of claim 4, wherein the premium currency is purchasable through the application.

6. The system of claim 1, wherein the processor is further configured to communicate with a website portal to allow a user to purchase or sell in-game currency.

7. The system of claim 6, wherein the processor is further configured to a communicate with the application to use the in-game currency to purchase in-game features.

8. The system of claim 7, wherein the in-game features can comprise at least one of new courses, additional statistics, and profile enhancements.

9. A method for creating an interactive remote golf game, comprising:
launching an application on a client computer;
receiving account login information;
communicating with a web database to verify login information;
displaying dashboard information;
receiving information regarding existing and possible golf rounds;
outputting information regarding currently playable rounds and tournaments;
receiving information from a user regarding a new golf round with a set of defined rules and options for play by multiple remote users;
sending data to the web database regarding new round and defined rules and options for additional players to access with other instances of the application.

10. The method of claim 9 wherein the new golf round can comprise one of a closest to the pin round, a stroke play round, and a match play round.

11. The method of claim 9, wherein the new golf round can a wagering round.

12. The method of claim 11, wherein the wagering comprises a premium currency.

13. The method of claim 12, wherein the premium currency is purchasable through the application.

14. The method of claim 9, further comprising communicating with a website portal to allow a user to purchase or sell in-game currency.

15. The method of claim 14, further comprising communicating with the application to use the in-game currency to purchase in-game features.

16. The method of claim 15, wherein the in-game features can comprise at least one of new courses, additional statistics, and profile enhancements.
